(19) United States
(12) Patent Application Publication
(10) Pub. No.: US 2014/0267772 A1
(43) Pub. Date: Sep. 18, 2014

(54) ROBOTIC TOTAL STATION WITH IMAGE-BASED TARGET RE-ACQUISITION

(71) Applicant: NOVATEL INC., Calgary (CA)

(72) Inventors: Kristian Morin, Calgary (CA); Guojiang Gao, Calgary (CA)

(73) Assignee: NOVATEL INC., Calgary (CA)

(21) Appl. No.: 13/832,653

(22) Filed: Mar. 15, 2013

(51) Int. Cl. H04N 5/232

(52) U.S. Cl. CPC H04N 5/232; Y10S 901/47
USPC 348/169

(57) ABSTRACT

A robotic total station includes a camera and a pattern recognition subsystem that automatically determine an azimuth angle to which to direct a laser on the total station for target re-acquisition. The camera records images that scan a search area of interest, and the pattern recognition subsystem processes the images to locate the target in one or more of the images as a predetermined pixel pattern that is based on a distinct characteristic of the target, such as a shape of the target, a color of the target, markings present on the target, and so forth. The subsystem calculates the azimuth angle of the target based on the location of the target in the images, the pointing direction of the camera and the known characteristics of the camera. The robotic total station then rotates to the azimuth angle and directs laser pulses to re-acquire the target.

### BACKGROUND OF THE INVENTION

1. Field of the Invention

The invention relates generally to robotic total stations and, more particularly, to robotic total stations that automatically re-acquire lost targets.

2. Background Information

Battery powered robotic total stations may be used for surveying, with only a single operative required to perform the survey. The operative moves a target to points of interest over a survey site, with the robotic total station following the movement of the target in a known manner, and calculating the position of the target relative to the total station at desired times and/or when the target is moved to a desired location in the work space. The total station includes a predictive filter, such as a Kalman filter, to aid in following the movement of the target.

The robotic total station includes a light source, preferably a pulsed laser light source, that emits a pulsed beam in the direction of the target periodically, at the desired times and/or when the target is at the desired locations. The target reflects the light back to the total station, and the total station determines the round-trip flight times for the respective pulses. The total station then uses the round-trip flight times to calculate the relative positions of the movable target. The robotic total station, which may perform the calculations to determine the positions of the target in real time or after the survey. The total station may also include a video camera and the total station may associate the calculated position information with the recorded video images.

The robotic total station works well as long as the moveable target is able to reflect the pulses back to the station. Each time the target is not so accessible, for example, when the target is moved behind trees or other obstructions that prevent the pulsed light from reaching the target and/or the reflected light from returning to the robotic total station, the robotic total station loses the target and must perform a relatively time consuming and battery power intensive search to re-acquire the target. The robotic total station may use the predictive filter to rotate in the direction of the predicted movement of the target, however, the robotic total station must then perform a search to re-acquire the target by directing the pulsed laser beam in a predetermined pattern over a search area until a reflected beam is received at the robotic total station.

The search is typically performed by directing the laser in a spiral pattern, with the laser providing the pulsed beam essentially continuously throughout the search process. Not only does the spiral search take significant time, the search consumes considerably more battery power than the normal survey operations of the total station. Accordingly, each spiral search performed may result in a corresponding limiting of the battery power available for the remainder of the survey, and thus, a premature end to the survey.

### SUMMARY OF THE INVENTION

A robotic total station includes a camera and a pattern recognition subsystem that automatically determine an azimuth angle to which to direct a laser on the total station for target re-acquisition. The camera records images that scan a search area of interest, and the pattern recognition subsystem processes the images to locate the target in one or more of the images as a predetermined pixel pattern that is based on a distinct characteristic of the target, such as a shape of the target, a color of the target, markings present on the target, and so forth. The subsystem calculates the azimuth angle of the target based on the location of the target in the images, the pointing direction of the camera and the known characteristics of the camera. The robotic total station then rotates to the azimuth angle and directs laser pulses to re-acquire the target.

As appropriate, the subsystem also calculates the elevation of the target from the images, and rotates the robotic total station to the calculated azimuth angle and elevation, such that the station locks directly into the target.

### BRIEF DESCRIPTION OF THE DRAWINGS

The invention description below refers to the accompanying drawings, of which:

FIG. 1 illustrates a robotic total station constructed in accordance with the invention;

FIG. 2 is a flow chart of the operations of a processing sub-system of the robotic total station constructed in accordance with the invention.

### DETAILED DESCRIPTION OF AN ILLUSTRATIVE EMBODIMENT

Referring to FIG. 1, a battery-powered robotic total station 100, consisting of a rotatable body 110 and legs 112, is located in a known position. At desired times, for example, periodically, the total station 100 transmits pulses from a laser (not shown) through a lens 114 in the direction of a target 150. The target 150, which includes one or more reflectors or prisms 155, reflects pulses back to the total station 100. The reflected pulses are received at the total station through the lens 114, or alternatively, or in addition, by a second lens (not shown).

A position processing subsystem 116, operating in a known manner, processes the received pulses to determine a roundtrip flight time between the total station 100 and the target 150, and then uses the flight time to determine the distance of the target from the total station. The total station then determines the relative position of the target based on the rotation angle of the body 110 and the calculated distance. The total station may then determine the global position of the target using the calculated relative position and the known global position of the total station, all in a known manner.

The battery-powered robotic total station 100 also includes a predictive model 118, that utilizes measurements and so forth to predict a next movement of the target. The predictive model may be a predictive filter, for example, a Kalman filter, which predicts the movement of the target 150 based on the position and/or movement information provided by the position processing subsystem 116 and/or respective sensors, such as, accelerometers, gyroscopes, and so forth (not shown), operating on the total station. The predictive model may instead, or in addition, perform a regression analysis based on the position measurements made during previous measurement epochs; an uplift analysis in which predetermined movements predict a next movement to be, for example, non-linear; a Bayes classifier analysis which predicts movement based, for example, on predetermined objects, e.g., trees, in the site; and so forth.

A controller 120 rotates the body 110 of the total station 100 relative to the legs 112, to follow the predicted movement of the target 150. The total station 100 determines the relative positions of the target at, for example, a desired spacing over a survey site and/or at desired locations over the survey site.

The robotic total station 100 further includes a camera 130, in the example, a video camera, that records images of the survey site as the total station rotates to follow the target 150. The position processing system 116, operating in a known manner, may associate the calculated positions with the recorded video images. The camera 130 may be fixed in position and move with the rotation of the body 110. Alternatively, or in addition, the camera may move independently to, for example, scan the survey site without requiring the rotation of the body of the total station.

Referring now also to FIG. 2, when the target 150 moves to a location that is blocked to the total station, for example, behind a tree 300, and thus, the target does not reflect laser pulses back to the robotic total station 100, the total station loses track of the target (Step 200). In response to the loss of the target, the controller 120 directs the video camera 130 to scan a search area, which may be an area surrounding a next predicted location of the target as determined by the predictive filter 118 or may be an area surrounding the last known position of the target at the time the target was lost to the total station. (Step 210). Notably, the laser need not be operated during the scan. If the camera moves with the rotation of the body 110, the controller rotates the body to move the camera for the scanning operation. If the camera moves independently, the controller moves only the camera to perform the scanning operation. Alternatively, the camera may include a lens that provides an essentially 360° view of the area, and thus, the camera and/or total station need not be rotated in order to acquire the images. Accordingly, step 210 is omitted and the system proceeds from step 200 to step 212.

A pattern recognition subsystem 132 processes the video images taken by the camera, to locate the target in the images as a predetermined pixel pattern based on one or more known characteristics of the target that are unique over the survey site. (Step 212). The pattern processing subsystem 132 may, for example, look for pixel patterns associated with one or more of the shape of the target, the color of the target, markings on target, and so forth.

Once the pixel pattern, and thus, the target, is located in one or more images, the pattern processing subsystem determines the azimuth angle of the target using the known characteristics of the camera and the corresponding pointing directions of the camera. (Step 214). The subsystem thus calculates the azimuth angle based on the known pointing directions of the camera when the respective images were taken, the known focal point and optical axis of the camera, and so forth. The pattern processing system may, for example, use a pin hole model in a known manner to determine the angle of the target relative to the optical axis of the camera, and use the pointing direction of the camera to determine the angle of the optical axis relative to magnetic or true north. The processing system then calculates the azimuth angle of the target using the two angles.

The controller 120 then rotates the total station 100 until the lens 114 is directed to the calculated azimuth angle of the target 150, and a limited search is performed using the laser to re-acquire the target. (Steps 216, 218). Alternatively, the camera 130 may be sufficiently precise that the elevation of the target can also be determined from the images. The total station is then directed to the location of the target using the azimuth angle and the elevation, and station locks onto the target without performing even the limited search.

Notably, there is no need to wait for communications between the operative and the total station in order to perform the operations to re-acquire the target. Thus, the re-acquisition operation is started as soon as the total station detects the loss of the target. Further, the time required to locate the target, that is, to find the known pixel pattern in the images, is relatively short, and thus, the reacquisition of the target may be accomplished quickly. Also, the battery power consumed to perform the processing to find the pixel pattern in the images and determine the corresponding azimuth angle is is much less than the battery power consumed to use the laser in the spiral searches performed by the known prior robotic total stations.

As discussed, the battery power consumed for target reacquisition is further minimized by the elimination of even the limited search if a precision camera is used, such that the elevation of the target can be calculated from the images.

Alternatively or in addition, an operative may control the start of the re-acquisition operation and/or may stop and re-start the operation to save battery power if, for example, the operative is interrupting or ending the survey.

The position processing subsystem 116 and the pattern recognition sub-system 132 may be combined, and the combination may utilize one or more processors in common. The camera 130 may be a still-image camera that records multiple contiguous or overlapping images of a scanned area. The camera may utilize a wide-angle lens, and thus, reduce the movement required to record images that scan the survey site.

What is claimed is:

1. A robotic total station including a laser;
a rotating body that supports the laser;
a camera with known characteristics that records images of a survey site;
a pattern recognition subsystem that calculates an azimuth angle for re-acquiring a target based on a location of the target in one or more of the recorded images and the corresponding pointing directions of the camera; and
a controller that during target re-acquisition operations
controls the movement of the camera to scan all or a portion of the survey site, and
rotates the rotating body to the calculated azimuth angle and operates the laser to re-acquire the target.

2. The robotic total station of claim 1 wherein the camera rotates with the rotating body and the controller rotates the body while the camera records the images that scan all or selected portions of the survey site.

3. The robotic total station of claim 2 wherein the camera is a video camera.

4. The robotic total station of claim 2 wherein the camera records multiple still images.

5. The robotic total station of claim 1 wherein the camera rotates independently of the rotation of the rotating body.

6. The robotic total station of claim 1 further including
a predictive filter that predicts a next location for the target based on a past location of the target, and
the controller controls the movement of the camera to record images that scan a portion of the survey site that includes the predicted next location for the target.

7. The robotic total station of claim 1 wherein the predetermined pixel pattern corresponds to one or more of a shape of the target, a color of the target, markings on the target.

8. The robotic total station of claim 1 wherein
the pattern recognition subsystem further calculates an elevation angle of the target from the one or more images, and
the controller further rotates the rotating body to the calculated elevation.

9. A method of operating a robotic total station to re-acquire a target including
directing a camera to record images that scan all or selected portions of the survey site;
processing the images and locating the target in one or more of the images as a predetermined pixel pattern;
calculating the azimuth angle of the target based on the locations of the target in the images relative to an optical axis of the camera and corresponding pointing directions of the camera;
rotating the robotic total station to the calculated azimuth angle and operating a laser to direct light to re-acquire the target.

10. The method of claim 9 further including
using a predictive model to predict movement of the target to a next location based on past movement of the target and/or objects in the survey site, and
controlling the movement of the camera to record images that scan at least a portion of the survey site that includes the predicted next location for the target.

11. The method of claim 9 wherein the step of recording the images includes recording video images.

12. The method of claim 9 wherein the step of recording the images includes recording still images.

13. The method of claim 9 wherein the locating of the predetermined pixel pattern further includes locating a pixel pattern that corresponds to one or more of a shape of the target, a color of the target, markings on the target.

14. The method of claim 9 wherein the camera includes a wide-angle lens that produces an image that includes all or the selected portion of the survey site.

15. The method of claim 9 further including
calculating an elevation angle of the target from the images, and
rotating the rotating body to the calculated elevation.

16. A robotic total station including
a laser;
a rotating body that supports the laser;
a camera with known characteristics that records images of a survey site, the camera having a wide-angle lens;
a pattern recognition subsystem that calculates an azimuth angle for re-acquiring a target based on a location of the target in one or more of the recorded images and the corresponding pointing directions of the camera; and
a controller that during target re-acquisition operations rotates the rotating body to the calculated azimuth angle and operates the laser to re-acquire the target.

17. The robotic total station of claim 16 wherein
the pattern recognition subsystem further calculates an elevation angle of the target from the images, and
the controller further rotates the rotating body to the calculated elevation.
